(19) United States
(12) Patent Application Publication
(10) Pub. No.: US 2026/0198738 A1
(43) Pub. Date: Jul. 16, 2026

(54) DUST COLLECTING APPARATUS, VACUUM CLEANER, AND CLEANING APPARATUS

(71) Applicant: Samsung Electronics Co., Ltd., Suwon-si (KR)

(72) Inventors: Dongjin CHO, Suwon-si (KR); Hyunju LEE, Suwon-si (KR); Youngjun CHO, Suwon-si (KR); Seungryong CHA, Suwon-si (KR); Ingyu CHOI, Suwon-si (KR)

(21) Appl. No.: 19/566,150

(22) Filed: Mar. 13, 2026

Related U.S. Application Data
(63) Continuation of application No. PCT/KR2024/009699, filed on Jul. 8, 2024.

(30) Foreign Application Priority Data
Sep. 27, 2023 (KR) 10-2023-0131166

(51) Int. Cl. A47L 9/16; A47L 9/00; B04C 5/185; B04C 5/26; B04C 5/28; B04C 9/00

(52) U.S. Cl. CPC A47L 9/1633; A47L 9/0063; A47L 9/1608; A47L 9/165; A47L 9/1666; A47L 9/1683; A47L 9/1691; B04C 5/185; B04C 5/26; B04C 5/28; B04C 9/00; B04C 2009/004; B04C 2009/007

(57) ABSTRACT

A dust collecting apparatus of a vacuum cleaner is provided. The apparatus includes a dust collection case including a foreign substance discharge port, a cyclone module configured to induce a swirling airflow to separate foreign substances inside the dust collection case, and a discharge door that is movable between an open position for opening the foreign substance discharge port and a blocking position for blocking the foreign substance discharge port, the cyclone module including a fixed portion fixed to the dust collection case, and a rotating portion that is selectively movable when the discharge door is in the open position, and the rotating portion includes a cyclone body including a central cyclone unit and a plurality of edge cyclone units and a rotary shaft arranged on the central cyclone unit such that the cyclone body is rotatable relative to the fixed portion.

### CROSS-REFERENCE TO RELATED APPLICATION(S

This application is a continuation application, claiming priority under 35 U.S.C. § 365(c), of an International application No. PCT/KR2024/009699, filed on July 8, 2024, which is based on and claims the benefit of a Korean patent application number 10-2023-0131166, filed on September 27, 2023, in the Ministry of Intellectual Property (MOIP), the disclosure of which is incorporated by reference herein in its entirety.

### BACKGROUND

### 1. Field

The disclosure relates to a dust collecting apparatus, a vacuum cleaner including the same, and a cleaning apparatus.

### 2. Description of Related Art

A vacuum cleaner is an electronic device that uses negative pressure to suck in air containing foreign substances, such as dust and then filters out the foreign substances inside a body. Such vacuum cleaners include a dust collecting apparatus that separates and collects foreign substances from the sucked-in air and discharges purified air.

As an example of a dust collecting apparatus, there is a cyclone type dust collecting apparatus that uses a centrifugal force to separate foreign substances, such as dust from the sucked-in air. The cyclone type dust collecting apparatus may include a dust collection case and a cyclone module for forming a cyclone inside the dust collection case.

Separated foreign substances are collected inside the dust collection case, and the collected foreign substances are to be removed periodically. However, if the user removes foreign substances from the dust collecting apparatus, the dust may be re-dispersed and increase the dust concentration indoors.

To reduce the inconvenience of users having to remove foreign substances themselves, a cleaner station that automatically discharges foreign substances inside the dust collecting apparatus may be considered.

However, even when using such a cleaner station, some foreign substances, such as hair may not be discharged from the dust collecting apparatus and may remain inside the dust collecting apparatus. In this case, the user is ultimately required to act to remove the remaining foreign substances, which reduces user convenience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a dust collecting apparatus, a vacuum cleaner including the same, and a cleaning apparatus.

Additional aspects will be set forth in part in the description which follows and, in part, will be apparent from the description, or may be learned by practice of the presented embodiments.

In accordance with an aspect of the disclosure, a dust collecting apparatus is provided. The dust collecting apparatus includes a dust collection case including a foreign substance discharge port, a cyclone module arranged inside the dust collection case and configured to induce a swirling airflow to separate foreign substances, and a discharge door that is movable between an open position that opens the foreign substance discharge port and a blocking position that blocks the foreign substance discharge port, wherein the cyclone module includes a fixed portion assembled to be fixed to the dust collection case, and a rotating portion that is movable in a vertical direction with respect to the fixed portion, has a rotation state that is rotatable relative to the fixed portion when the discharge door is in the open position, and has a locked state in which rotation relative to the fixed portion is restricted when the discharge door is in the blocking position, and wherein the rotating portion includes a cyclone body including a central cyclone unit arranged at a center of rotation and a plurality of edge cyclone units arranged around the central cyclone unit, and a rotary shaft arranged on the central cyclone unit such that the cyclone body is rotatable relative to the fixed portion, and providing a path for transferring air discharged from the central cyclone unit to the fixed portion.

In accordance with another aspect of the disclosure, a vacuum cleaner is provided. The vacuum cleaner includes a dust collecting apparatus including a dust collection case including a foreign substance discharge port, a cyclone module arranged inside the dust collection case and configured to induce a swirling airflow to separate foreign substances, and a discharge door that is movable between an open position that opens the foreign substance discharge port and a blocking position that blocks the foreign substance discharge port, wherein the cyclone module includes a fixed portion assembled to be fixed to the dust collection case, and a rotating portion that is movable in a vertical direction with respect to the fixed portion, has a rotation state that is rotatable relative to the fixed portion when the discharge door is in the open position, and has a locked state in which rotation relative to the fixed portion is restricted when the discharge door is in the blocking position, and wherein the rotating portion includes a cyclone body including a central cyclone unit arranged at a center of rotation and a plurality of edge cyclone units arranged around the central cyclone unit, and a rotary shaft arranged on the central cyclone unit such that the cyclone body is rotatable relative to the fixed portion, and providing a path for transferring air discharged from the central cyclone unit to the fixed portion.

In accordance with another aspect of the disclosure, a cleaning apparatus is provided. The cleaning apparatus includes a vacuum cleaner including a dust collecting apparatus, and a cleaner station including a docking portion to which the dust collecting apparatus is connectable, a suction portion that provides suction power to discharge foreign substances collected in the dust collecting apparatus, and a collecting portion that collects the discharged foreign substances.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a cleaning apparatus according to an embodiment of the disclosure;

FIG. 2 is an exploded perspective view of a dust collecting apparatus of a vacuum cleaner, according to an embodiment of the disclosure;

FIG. 3 is an exploded perspective view of a cyclone module of a dust collecting apparatus, according to an embodiment of the disclosure;

FIG. 4 is a cross-sectional view of a dust collecting apparatus according to an embodiment of the disclosure;

FIG. 5 is a cross-sectional view of a cleaning apparatus according to an embodiment of the disclosure;

FIG. 6 is a cross-sectional view of a cleaning apparatus according to an embodiment of the disclosure;

FIG. 7 is an exploded perspective view of a dust collecting apparatus, showing, at different angles, a fixed portion and a rotating portion of a cyclone module, separated from each other according to an embodiment of the disclosure;

FIG. 8 is a perspective view illustrating a rotating portion rotating relative to a fixed portion of a cyclone module in a dust collecting apparatus, according to an embodiment of the disclosure;

FIG. 9 is a diagram illustrating a structure in which a rotating portion is supported to be rotatable relative to a fixed portion in a cyclone module according to an embodiment of the disclosure;

FIG. 10 is a diagram illustrating a structure in which a rotary shaft of a rotating portion is supported by a fixed portion in a cyclone module according to an embodiment of the disclosure;

FIG. 11 is a diagram illustrating a first movement restriction portion of a rotary shaft, is detachably assembled according to an embodiment of the disclosure;

FIG. 12 is a cross-sectional view illustrating an appearance of a dust collecting apparatus when a discharge door is in a blocking position according to an embodiment of the disclosure;

FIG. 13 is an enlarged view focused on a rotation support portion of a dust collecting apparatus of FIG. 12 according to an embodiment of the disclosure;

FIG. 14 is a cross-sectional view illustrating an appearance of a dust collecting apparatus when a discharge door is in an open position according to an embodiment of the disclosure;

FIG. 15 is an enlarged view focused on a rotation support portion of a dust collecting apparatus of FIG. 14 according to an embodiment of the disclosure;

FIG. 16 is a horizontal cross-sectional view of a cyclone body of FIG. 9 according to an embodiment of the disclosure;

FIG. 17 is a diagram illustrating a function of a cyclone body in a cyclone module, according to an embodiment of the disclosure;

FIG. 18 is an exploded perspective view illustrating a cyclone body of a dust collecting apparatus, according to an embodiment of the disclosure;

FIG. 19 is an assembled perspective view of a cyclone body of FIG. 18 according to an embodiment of the disclosure; and

FIG. 20 is a diagram illustrating an operation of a cyclone body of FIG. 19 according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms that include ordinal numbers, such as "first," "second," or the like, may be used to describe various components, but the components are not limited by the terms. The terms are used solely to distinguish one component from another. For example, without departing from the scope of the disclosure, a first component could be referred to a second component, and similarly, a second component could also be referred to as a first component. The term "and/or" includes any combination of a plurality of related items or any single item among the plurality of related items.

The terms used in the application are used to describe embodiments and are not intended to limit and/or restrict the disclosure. Singular expressions include plural expressions unless the context clearly indicates otherwise. In the specification, terms, such as "include" or "have" are to be understood as being not intended to specify the presence of a feature, number, step, operation, component, part or combination thereof described in the specification, but do not exclude in advance the possibility of the presence or addition of one or more other features, numbers, steps, operations, components, parts or combinations thereof. The same reference numerals in each drawing indicate elements that perform substantially the same function.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

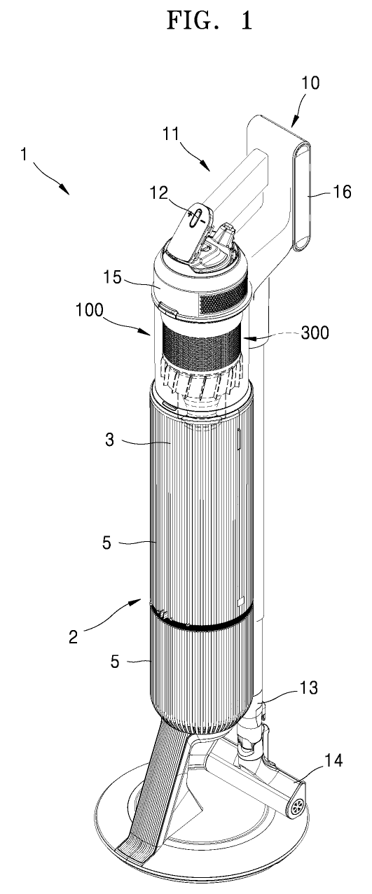

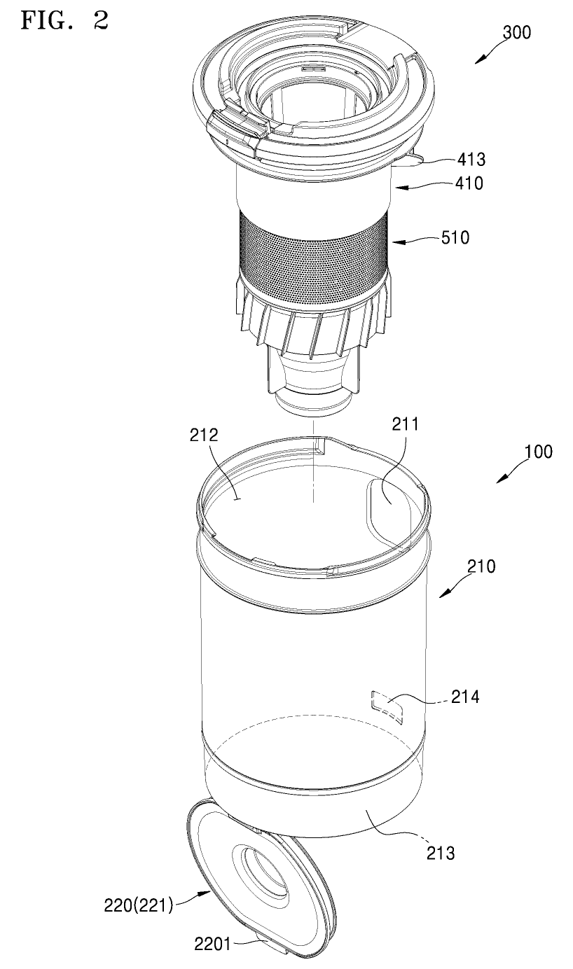

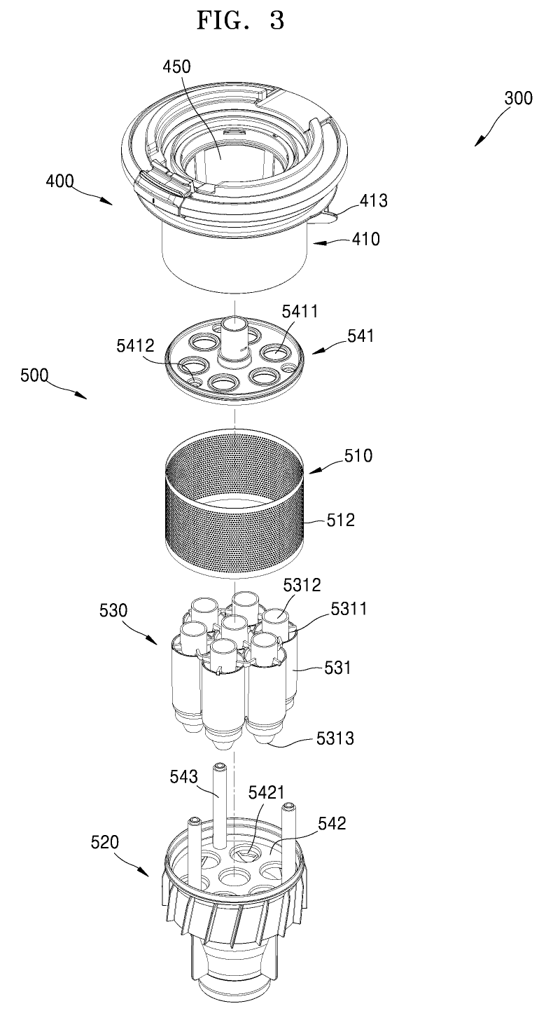

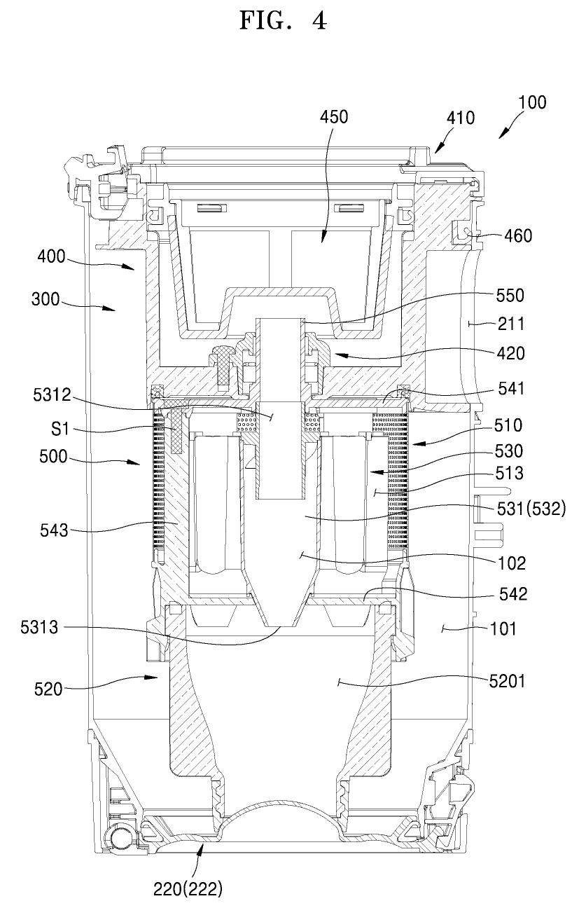

FIG. 1 is a diagram illustrating a cleaning apparatus according to an embodiment of the disclosure. FIG. 2 is an exploded perspective view of a dust collecting apparatus of a vacuum cleaner according to an embodiment of the disclosure. FIG. 3 is an exploded perspective view of a cyclone module of a dust collecting apparatus according to an embodiment of the disclosure. FIG. 4 is a cross-sectional view of a dust collecting apparatus according to an embodiment of the disclosure.

Referring to FIG. 1, a cleaning apparatus 1 may include a vacuum cleaner 10 including a dust collecting apparatus 100, and a cleaner station 2 connected to the dust collecting apparatus 100 to suck in foreign substances contained in the dust collecting apparatus 100 and remove the foreign substances from the dust collecting apparatus 100.

The vacuum cleaner 10 may include a main body 11, a suction pipe 13 detachably coupled to the main body 11, a cleaner head 14 detachably coupled to the suction pipe 13, and the dust collecting apparatus 100 detachably coupled to the main body 11. Foreign substances, such as dust in the air or hair that enter through the cleaner head 14 may be collected in the dust collecting apparatus 100.

The vacuum cleaner 10 may include a filter housing 15. A dust collection filter may be arranged in the filter housing 15. The type of dust filter is not limited, but a high-efficiency particulate air (HEPA) filter may be used, for example. The dust collection filter may filter ultrafine dust, or the like, that is not filtered by the dust collecting apparatus 100. The filter housing 15 may include an outlet such that air passing through the filter is discharged to the outside of the vacuum cleaner 10. The vacuum cleaner 10 may include a handle such that a user may grasp and operate the vacuum cleaner 10.

The main body 11 may include a battery 16 provided to provide driving force to the vacuum cleaner 10. The battery 16 may be detachably mounted on the main body 11. The main body 11 may include an operation unit 12. A user may turn the vacuum cleaner 10 on/off or adjust the suction strength by operating a power button, or the like, provided on the operation unit 12.

The cleaner station 2, according to an embodiment of the disclosure, may include a docking portion 3 provided such that the dust collecting apparatus 100 of the vacuum cleaner 10 is connected thereto. The dust collecting apparatus 100 that is not separated from the vacuum cleaner 10 may be mounted on the docking portion 3 of the cleaner station 2. However, the state of the dust collecting apparatus 100 connected to the docking portion 3 is not limited thereto, and only the dust collecting apparatus 100 may be separated from the vacuum cleaner 10 and docked to the docking portion 3.

The cleaner station 2 may include an input unit (not shown) capable of receiving input from a user. The input unit may be configured using buttons, switches, or the like. However, the position and type of the input unit are not limited thereto, and any position and type for receiving input from the user may be used without limitation.

When the dust collecting apparatus 100 is connected to the docking portion 3, the cleaner station 2 may be arranged to change the suction airflow supplied to the dust collecting apparatus 100 such that foreign substances collected inside the dust collecting apparatus 100 are automatically discharged.

Referring to FIG. 2, the dust collecting apparatus 100, according to an embodiment of the disclosure, may include a dust collection case 210, a discharge door 220, and the cyclone module 300.

The dust collection case 210 may include an air inlet 211 and an air outlet 212. The air inlet 211 may be provided on a side portion of the dust collection case 210, and the air outlet 212 may be provided at an upper portion of the dust collection case 210. The dust collection case 210 may have a hollow cylindrical shape, and a foreign substance discharge port 213 for dust discharge may be provided at the bottom thereof. However, the arrangement of the air inlet 211, the air outlet 212, and the foreign substance discharge port 213 in the dust collection case 210 is not limited thereto and may be modified in various manners.

The discharge door 220 is arranged at the bottom of the dust collection case 210 and opens and closes the foreign substance discharge port 213. The discharge door 220 is movable between an open position 221 that opens the foreign substance discharge port 213 and a blocking position (222 of FIG. 4) that blocks the foreign substance discharge port 213. The dust collection case 210 may include a door lock 214 configured to maintain the discharge door 220 in the blocking position 222. The door lock 214 supports an end 2201 of the discharge door 220 such that the discharge door 220 maintains the blocking position 222. When the door lock 214 is pressed by an external force, the door lock 214 and the end 2201 of the discharge door 220 may be separated from each other, and the discharge door 220 may be switched from the blocking position 222 to the open position 221.

When the discharge door 220 is in the blocking position 222, air may be drawn in from the outside through the air inlet 211, and the air outlet 212 may discharge air from which foreign substances have been separated. When the discharge door 220 is in the blocking position 222, an upper surface of the discharge door 220 forms a bottom surface of the dust collection case 210.

The cyclone module 300 is arranged inside the dust collection case 210. The cyclone module 300 is inserted into the dust collection case 210 through the air outlet 212. The cyclone module 300 may be configured to separate foreign substances by inducing a swirling airflow of air introduced into the interior of the dust collection case 210. The cyclone module 300 may separate foreign substances contained in the introduced air, by inducing a swirling airflow of the air introduced through the air inlet 211.

Referring to FIGS. 2 to 4, the dust collecting apparatus 100 may form a multi-cyclone. For example, the cyclone module 300 of the dust collecting apparatus 100 may form a first cyclone 101 between the dust collection case 210 to primarily separate foreign substances from air drawn in through the air inlet 211, and may form a second cyclone 102 to secondarily separate foreign substances from the air from which foreign substances have been primarily separated by the first cyclone 101 and discharge the air from which the foreign substances have been separated to the outside through the air outlet 212.

The cyclone module 300 may include an inner case 510, a cyclone body 530 disposed inside the inner case 510, a dust separation member 520 disposed under the inner case 510, and a mounting member 410 disposed above the inner case 510.

The inner case 510 is arranged inside the dust collection case 210 and is spaced apart from the inner surface of the dust collection case 210. The inner case 510 includes a mesh filter 512 surrounding the cyclone body 530. The inner case 510 may have a cylindrical shape.

The mesh filter 512 may allow air to move toward the cyclone body 530. The mesh filter 512 includes a number of holes, such as a grill or filter, to allow air to pass through but prevent large foreign substances from passing through.

The inner case 510 may function as a boundary that separates the first cyclone 101 from the second cyclone 102. The internal space of the inner case 510 may form an intermediate chamber 513 in which air discharged through the mesh filter 512 from the first cyclone 101 is collected. The cyclone body 530 may be arranged in the intermediate chamber 513.

The cyclone body 530 may include a plurality of cyclone units 531 forming the second cyclone 102. Each of the plurality of cyclone units 531 may have a foreign substance discharge port 5313 disposed at a lower portion thereof through which foreign substance is discharged, and an air outlet 5312 disposed at a top thereof through which air is discharged.

Air passing through the mesh filter 512 may be introduced into each of the plurality of cyclone units 531, and foreign substances in the introduced air may be discharged downward through the foreign substance discharge port 5313, and air from which foreign substances have been removed may be discharged upward through the air outlet 5312.

The mounting member 410 may be arranged on the cyclone body 530. The mounting member 410 may be mounted on the dust collection case 210. A sealing member 460 may be arranged between the mounting member 410 and the dust collection case 210.

On an outer surface of the mounting member 410, a flow guide portion 413 may be arranged to guide movement of air introduced through the air inlet 211 of the dust collection case 210. The flow guide portion 413 guides the air introduced through the air inlet 211 to form a swirling airflow that rotates around the cyclone module 300.

An upper plate 541 may be arranged on the cyclone body 530. The upper plate 541 may be arranged between the cyclone body 530 and the mounting member 410. The upper plate 541 may be arranged between the inner case 510 and the mounting member 410. The upper plate 541 may be arranged on the intermediate chamber 513. The upper plate 541 may have a plurality of holes 5411 into which or to which the air outlets 5312 of the plurality of respective cyclone units 531 are inserted or connected.

A lower plate 542 and the dust separation member 520 may be arranged under the cyclone body 530. The dust separation member 520 may have a dust collecting chamber 5201 in which foreign substances separated from the cyclone body 530 are collected. The dust separation member 520 includes a dust storage portion 521 for storing foreign substances, and a support wall 522 arranged between the dust storage portion 521 and the inner case 510. The support wall 522 may support a lower portion of the inner case 510.

The lower plate 542 may be arranged within the dust separation member 520. The lower plate 542 may be fixed to the dust separation member 520. The lower plate 542 may be a circular plate.

The lower plate 542 partitions a space between the dust collecting chamber 5201 of the dust separation member 520 and the intermediate chamber 513 in which the cyclone body 530 is installed. The lower plate 542 may have a plurality of holes 5421 into which the foreign substance discharge ports 5313 formed at lower ends of the plurality of cyclone units 531 may be inserted.

The upper plate 541 and the lower plate 542 may be fixed to each other with the cyclone body 530 therebetween. In other words, the lower plate 542 may support the cyclone body 530 together with the upper plate 541. For example, the upper plate 541 and the lower plate 542 may be fixed to each other by a plurality of support columns 543. The plurality of support columns 543 may be arranged between the upper plate 541 and the lower plate 542. The plurality of support columns 543 may be arranged on a periphery of the cyclone body 530. For example, the plurality of support columns 543 extending in a vertical direction may be provided on the lower plate 542, and a fastening member S1 may be coupled to the plurality of support columns 543 through fastening holes 5412 of the upper plate 541. As the fastening member S1 is coupled, the upper plate 541 and the lower plate 542 may be fixed.

The cyclone body 530 may be arranged between the upper plate 541 and the lower plate 542. In each of the plurality of cyclone units 531, a lower region in which the foreign substance discharge ports 5313 are arranged may be arranged in the holes 5421 of the lower plate 542, and an upper region in which the air outlets 5312 are arranged may be arranged in the holes 5411 of the upper plate 541. The cyclone body 530 may be fixed by the upper plate 541, the lower plate 542, and the plurality of support columns 543.

Referring to FIGS. 3 and 4, the mounting member 410, the inner case 510, and the dust separation member 520 form an outer surface of the cyclone module 300. The cyclone module 300 is arranged such that a center thereof is coaxial with a center of the dust collection case 210. The outer surface of the cyclone module 300 is spaced apart from the inner surface of the dust collection case 210. The first cyclone 101 is formed between the outer surface of the cyclone module 300 and the inner surface of the dust collection case 210.

Air drawn into the air inlet 211 passes through the flow guide portion 413 and forms an air current that circles around the cyclone module 300. In the first cyclone 101, large foreign substances, such as hair or dust greater than the holes of the mesh filter 512, are first separated from the air introduced through the air inlet 211 by centrifugal force. The separated large foreign substances are accumulated on the bottom surface of the dust collection case 210, which is formed by the discharge door 220.

Air from which large foreign substances have been separated flows into the intermediate chamber 513 through the mesh filter 512 of a cyclone barrier 511. In the second cyclone 102 formed by each of the plurality of cyclone units 531, small foreign substances, such as fine dust are separated by centrifugal force and gravity. Foreign substances separated in the second cyclone 102 pass through the foreign substance discharge port 5313 of the cyclone unit 531 and move to the dust collecting chamber 5201 of the dust separation member 520 and accumulate. The air from which foreign substances have been separated in the second cyclone 102 is discharged through the air outlet 5312. The air discharged through the air outlet 5312 passes through a dust collection filter 450 and is discharged to the outside.

The dust collecting chamber 5201 is opened and closed by the discharge door 220. When the discharge door 220 is in the open position 221, foreign substances collected in the dust collecting chamber 5201 may be discharged. Additionally, when the discharge door 220 is in the open position 221, relatively large foreign substances collected between the dust collection case 210 and the outer surface of the cyclone module 300 may be discharged.

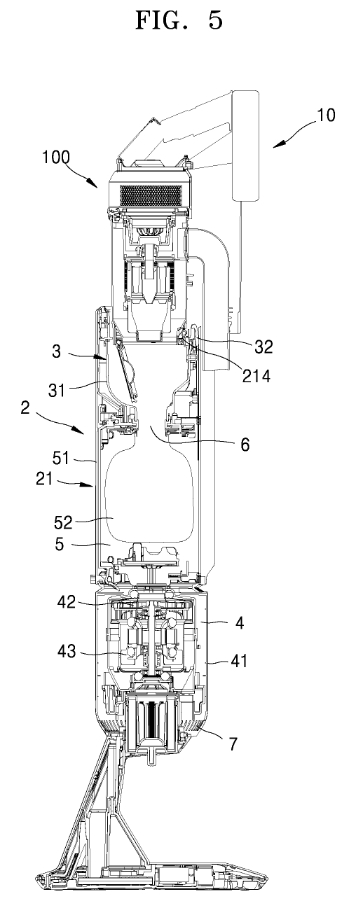

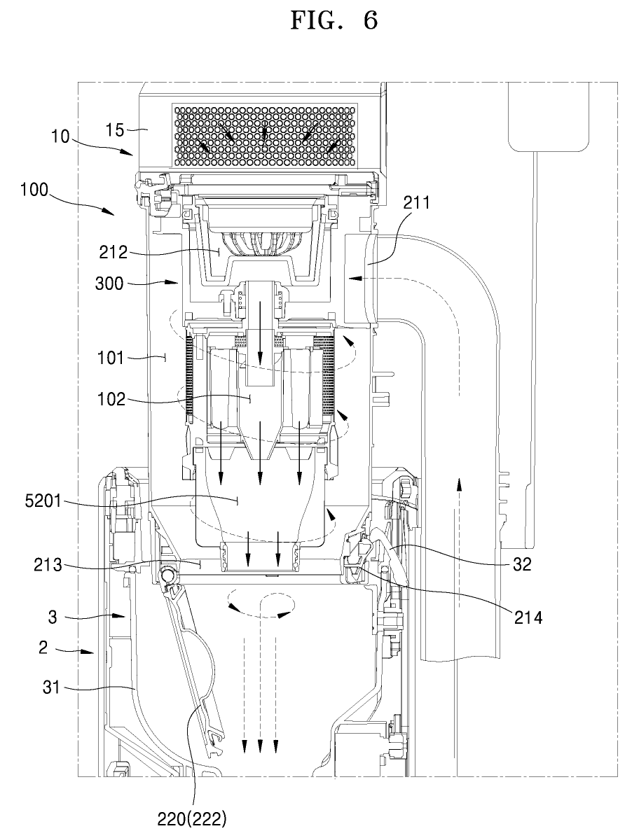

FIG. 5 is a cross-sectional view of a cleaning apparatus according to an embodiment of the disclosure. FIG. 6 is a portion of a cross-sectional view of a cleaning apparatus according to an embodiment of the disclosure.

Referring to FIGS. 1 and 5, the cleaner station 2, according to an embodiment of the disclosure, may include a suction portion 4 and discharge foreign substances collected in the dust collecting apparatus 100 from the dust collecting apparatus 100. The suction portion 4 may be arranged inside a station body 21 and include a suction fan 42 that moves air and a suction motor 43 that rotates the suction fan 42.

The cleaner station 2, according to an embodiment of the disclosure, may include a collecting portion 5 in which foreign substances discharged from the dust collecting apparatus 100 are collected. The collecting portion 5 may be arranged inside the station body 21. The collecting portion 5 may be arranged upstream of the airflow than the suction portion 4.

The cleaner station 2, according to an embodiment of the disclosure, may include one end connected to the dust collecting apparatus 100 and the other end connected to the suction portion 4, and may include a suction path 6 through which air moved by the suction portion 4 flows.

Specifically, the suction path 6 may connect the docking portion 3 to the suction portion 4. Here, the collecting portion 5 may be provided on the suction path 6. For example, the suction path 6 connects the docking portion 3 to the collecting portion 5, thereby allowing foreign substances discharged from the dust collecting apparatus 100 to be sucked into the collecting portion 5 through the docking portion 3.

The docking portion 3 may include a mounting groove 31 which is communication with the suction path 6 and in which the dust collecting apparatus 100 is mounted.

The mounting groove 31 is a space that is opened to the outside from the docking portion 3, and the dust collecting apparatus 100 may be inserted and mounted in the mounting groove 31. When the dust collecting apparatus 100 is installed in the mounting groove 31, docking between the dust collecting apparatus 100 and the cleaner station 2 may be completed.

Although not shown in the drawing, a sensor for detecting whether the dust collecting apparatus 100 is connected may be provided inside the mounting groove 31. Thus, when the dust collecting apparatus 100 is installed in the mounting groove 31, the cleaner station 2 may determine a docking state of the dust collecting apparatus 100 and the cleaner station 2 based on an output value of the sensor.

The cleaner station 2 may include an opening guide 32 configured to open the discharge door 220 when the dust collecting apparatus 100 is connected to the cleaner station 2.

For example, referring to FIGS. 2 and 5, the opening guide 32 may be configured to pressurize the door lock 214 of the dust collecting apparatus 100. The opening guide 32 may be formed as a portion of an inner surface of the mounting groove 31. However, the disclosure is not limited thereto, and the opening guide 32 may be provided in the shape of a region protruding from the inner surface of the mounting groove 31 toward a center or a projection, rib, or the like, protruding toward a center from the inner surface. However, the position and type of the opening guide 32 are not limited to the above example, and any structure that may open the discharge door 220 when the dust collecting apparatus 100 is installed may be used as the opening guide 32 without limitation.

When the dust collecting apparatus 100 is docked to the docking portion 3, the door lock 214 is automatically pressed against the opening guide 32 such that the discharge door 220 is opened as the dust collecting apparatus 100 is docked to the cleaner station 2.

The suction path 6 may be connected to the suction portion 4 by passing through the station body 21 from the docking portion 3. The suction path 6 may transfer a suction force generated by the suction portion 4 to the dust collecting apparatus 100, thereby forming a suction airflow from the dust collecting apparatus 100 toward the suction portion 4. For example, the suction force generated by the suction portion 4 may be transmitted to the inside of the dust collecting apparatus 100 through the suction path 6 along the collecting portion 5 and the mounting groove 31, such that foreign substances inside the dust collecting apparatus 100 are discharged from the dust collecting apparatus 100 to the mounting groove 31 along the suction airflow, and the discharged foreign substances may be collected in the collecting portion 5 through the suction path 6.

The collecting portion 5 may include a collecting portion housing 51 and a dust bag 52 that is arranged in an internal space of the collecting portion housing 51 and collects foreign substances introduced through the suction path 6.

The collecting portion housing 51 may form an internal space. For example, the collecting portion housing 51 may correspond to a portion of the suction path 6, and for convenience of described, is described as a separate component.

The dust bag 52 is formed of a material that allows air to pass through but does not allow foreign substances to pass through, such that foreign substances flowing into the collecting portion 5 from the dust collecting apparatus 100 may be collected. The dust bag 52 may be provided on the suction path 6, and the dust bag 52 may be provided so as to be separable from the collecting portion 5.

The suction portion 4 may include the suction fan 42 and the suction motor 43 that rotates the suction fan 42, and may include a suction portion housing 41 that forms an internal space in which the suction fan 42 is arranged. The suction portion housing 41 may be arranged in the station body 21, and an outlet 7 for discharging air sucked in by the suction fan 42 may be provided.

The suction force formed by the suction fan 42 may be transmitted to the dust collecting apparatus 100 through the collecting portion 5 via the suction path 6 in the internal space of the suction portion housing 41.

The cleaner station 2 may, according to an embodiment of the disclosure, selectively change a suction flow rate supplied to the dust collecting apparatus 100. As an example, changes in suction flow rate may be induced by control of the suction motor. As another example, changes in suction flow rate may be induced by a flow control device (not shown) that controls a cross-sectional area of a suction path through which a suction airflow travels.

As described above, by rotating the suction fan 42, a suction airflow may be induced from the dust collecting apparatus 100 toward the suction portion 4, and the air sucked from the dust collecting apparatus 100 may be discharged to the outside of the cleaner station 2 through the collecting portion 5. In addition, by selectively changing the suction flow rate supplied to the dust collecting apparatus 100, foreign substances collected in the dust collecting apparatus 100 may be induced to be discharged more efficiently.

Referring to FIG. 6, air movement is generated inside the dust collecting apparatus 100 due to suction power of the cleaner station 2. For example, air is drawn in through the air inlet 211 and the air outlet 212, the air drawn in through the air inlet 211 passes through the first cyclone 101 and is discharged through the foreign substance discharge port 213, and the air drawn in through the air outlet 212 passes through the second cyclone 102 and is discharged through the foreign substance discharge port 213.

For example, air drawn in through the air inlet 211 moves along the outer surface of the cyclone module 300 and is discharged through the foreign substance discharge port 213, and air drawn in through the filter housing 15 passes through the air outlet 212, the cyclone unit 531, and the dust collecting chamber 5201, and is discharged through the foreign substance discharge port 213. Thus, foreign substances included inside the dust collecting apparatus 100 may be quickly discharged to the docking portion 3 of the cleaner station 2.

Meanwhile, as described above, even if the foreign substances collected inside the dust collecting apparatus 100 are discharged by the suction power of the cleaner station 2, some foreign substances, such as hair wrapped around the outer surface of the cyclone module 300, may remain inside the dust collecting apparatus 100.

The dust collecting apparatus 100, according to an embodiment of the disclosure, may have a structure in which a portion of the cyclone module 300 may rotate in order to minimize foreign substances remaining inside the dust collection case 210. As the portion of the cyclone module 300 rotates, some foreign substances, such as hair may be separated from a surface of the cyclone module 300 and discharged through the foreign substance discharge port 213.

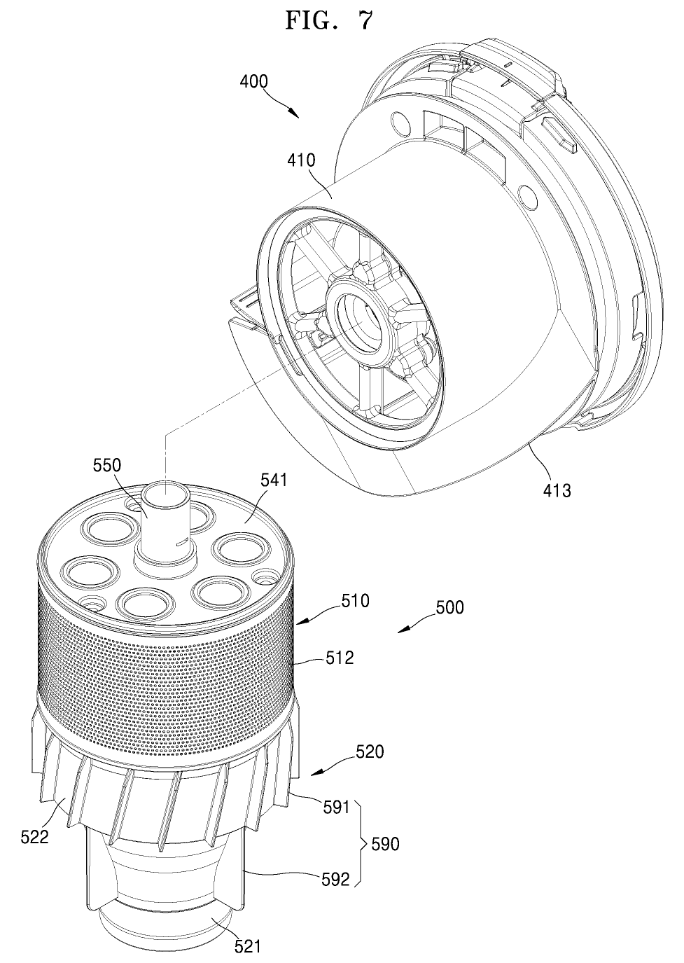

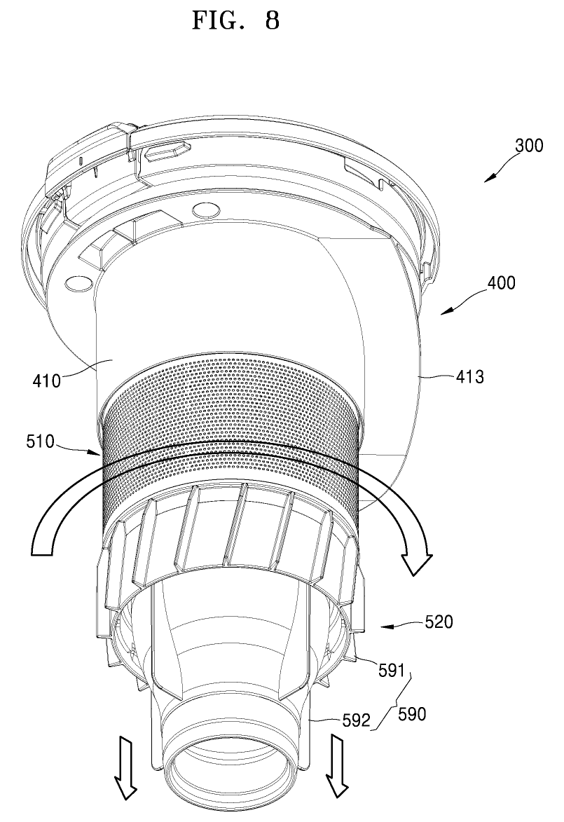

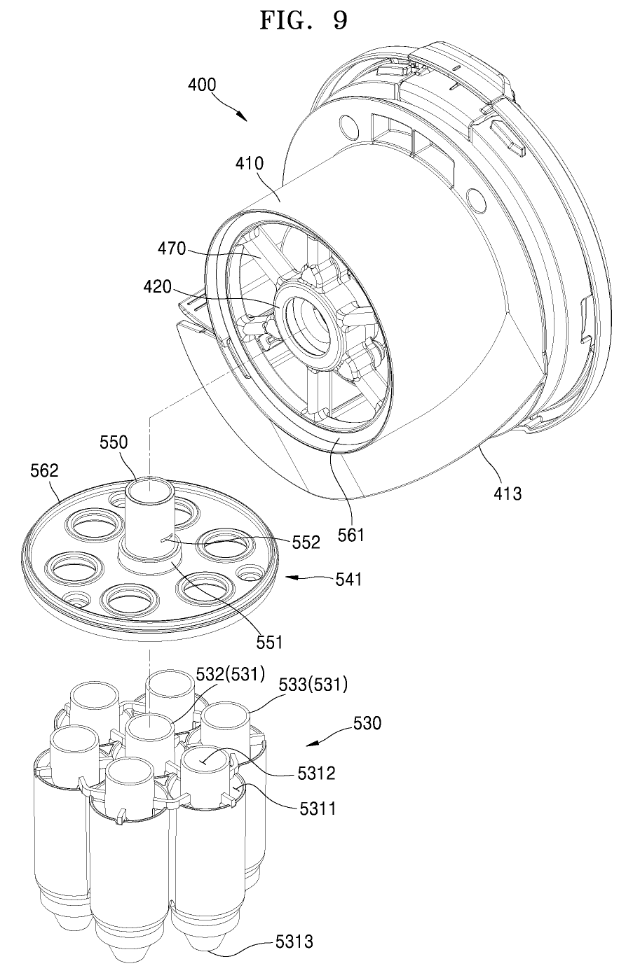

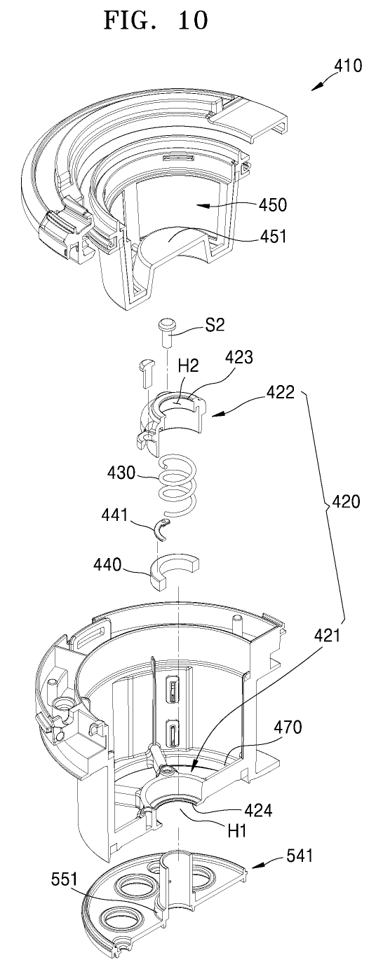

FIG. 7 is an exploded perspective view of a dust collecting apparatus according to an embodiment of the disclosure, showing, at different angles, a fixed portion and a rotating portion of a cyclone module, separated from each other. FIG. 8 is a perspective view illustrating a rotating portion rotating relative to a fixed portion of a cyclone module in a dust collecting apparatus according to an embodiment of the disclosure. FIG. 9 is a diagram illustrating a structure in which a rotating portion is supported to be rotatable relative to a fixed portion in a cyclone module according to an embodiment of the disclosure. FIG. 10 is a diagram illustrating a structure in which a rotary shaft of a rotating portion is supported on a fixed portion in a cyclone module according to an embodiment of the disclosure.

Referring to FIGS. 4, 7, and 8, the cyclone module 300, according to an embodiment of the disclosure, may include the fixed portion 400 fixed to the dust collection case 210 and the rotating portion 500 which is rotatable relative to the fixed portion 400.

The fixed portion 400 may be configured to be fixed and not rotate in the cyclone module 300, and may be mounted to be fixed to the dust collection case 210. For example, the fixed portion 400 includes the mounting member 410 mounted on the dust collection case 210.

The rotating portion 500 may be a rotatable component in the cyclone module 300 and arranged below the fixed portion 400. For example, the rotating portion 500 may be arranged below the mounting member 410.

The rotating portion 500 may include an inner case 510 including the mesh filter 512 and the dust separation member 520 assembled to the inner case 510. The rotating portion 500 may further include the cyclone body 530 disposed inside the inner case 510. The rotating portion 500 may further include the upper plate 541 and the lower plate 542 that supports the cyclone body 530 together with the upper plate 541. When the rotating portion 500 rotates, the inner case 510, the dust separation member 520, and the cyclone body 530 arranged therein may rotate together.

The rotating portion 500 may be rotatably supported on the fixed portion 400. For example, the rotating portion 500 may include the rotary shaft 550 configured to be rotatable relative to the mounting member 410.

The rotary shaft 550 may be arranged on a central cyclone unit 532 such that the cyclone body 530 is rotatable relative to the fixed portion 400. The rotary shaft 550 may be provided on the upper plate 541. The rotary shaft 550 may be arranged to protrude upward from a center of the upper plate 541.

The rotary shaft 550 may be connected to the air outlet 5312 of the central cyclone unit 532 among the plurality of cyclone units 531. In order not to obstruct the airflow of the air outlet 5312, a diameter of the rotary shaft 550 may correspond to a diameter of the air outlet 5312. The diameter of the rotary shaft 550 may be the same as the diameter of the air outlet 5312. However, the relationship between the diameter of the rotary shaft 550 and the diameter of the air outlet 5312 is not limited thereto and may vary.

The rotary shaft 550 may be a separate component from the air outlet 5312 of the central cyclone unit 532. However, the structure of the rotary shaft 550 and the air outlet 5312 of the central cyclone unit 532 is not limited thereto. For example, the rotary shaft 550 and the air outlet 5312 of the central cyclone unit 532 may be one body. For example, the rotary shaft 550 may be an extension of the air outlet 5312 of the central cyclone unit 532.

The fixed portion 400 may include a rotation support portion 420 that rotatably supports the rotary shaft 550. The rotation support portion 420 may be fixed to an inner surface of the mounting member 410 by a plurality of support ribs 470 that are radially arranged. The rotary shaft 550 may be inserted and assembled into the interior of the rotation support portion 420. By the rotary shaft 550 assembled to the rotation support portion 420, the rotating portion 500 may be rotated relative to the fixed portion 400.

As described above, by arranging the rotary shaft 550 and the rotation support portion 420 that rotatably supports the rotating portion 500 relative to the fixed portion 400, at an upper center of the rotating portion 500, the structure for rotation of the rotating portion 500 may be simplified, and a resulting weight increase may be minimized.

The rotating portion 500 may be configured to rotate by airflow introduced into the interior of the dust collection case 210 in a rotating state 501. For example, as shown in FIGS. 5 and 6, when the discharge door 220 is in the open position, airflow may be introduced through the air inlet 211 and the air outlet 212 of the dust collection case 210. By the airflow introduced, foreign substances separated by the cyclone module 300 may be discharged through the foreign substance discharge port 213. The rotating portion 500 may include a rotation induction portion 590 configured to receive a rotating force by an airflow introduced through at least one of the air inlet 211 and the air outlet 212. The rotation speed of the rotating portion 500 may be 300 rpm (revolution per minute) or more and 10,000 rpm or less.

As an example, the rotation induction portion 590 may include a plurality of rotation blades 591, 592 provided on an outer surface of the rotating portion 500. For example, the plurality of rotation blades 591, 592 may be provided on an outer surface of the dust separation member 520. The rotation blade 591 may be rotated by airflow introduced through the air inlet 211.

The plurality of rotation blades 591, 592 may extend in a direction perpendicular to or inclined with respect to a direction of movement of the air. For example, the plurality of rotation blades 591, 592 may extend in the vertical direction or an inclined direction relative to the vertical direction.

For example, the plurality of rotation blades 591, 592 may be arranged under the mesh filter 512. The plurality of rotation blades 591, 592 may include a plurality of first rotation blades 591 arranged on an outer surface of the support wall 522 and a plurality of second rotation blades 592 arranged on an outer surface of the dust storage portion 521. However, the arrangement of the plurality of rotation blades 591, 592 is not limited thereto and may vary. For example, although not shown, the plurality of rotation blades 591, 592 may be arranged on an outer surface of the inner case 510.

In the example described above, description is focused on an example in which the rotation induction portion 590 is provided on the outer surface of the rotating portion 500, but is not limited thereto, and may be provided on both the inner surface and the outer surface of the rotating portion 500, or on either the inner surface or the outer surface of the rotating portion 500.

Referring to FIGS. 9 and 10, in the cyclone module 300 according to an embodiment of the disclosure, the rotating portion 500 further includes a bearing 440 provided on the outer surface of the rotary shaft 550, and the fixed portion 400 includes the rotation support portion 420 that supports the bearing 440 such that the rotary shaft 550 may rotate.

The bearing 440 may be assembled to the rotary shaft 550. The bearing 440 may be arranged coaxially with a rotation center of the rotating portion 500. With the bearing 440 arranged coaxially with the rotation center, rotation may be possible by a relatively small force compared to a bearing structure arranged on the periphery of the rotating portion 500.

The rotation support portion 420 may be configured such that the rotary shaft 550 passes therethrough. For example, the rotation support portion 420 may include an upper support portion 422 having an upper through hole H2 through which the rotary shaft 550 passes, and a lower support portion 421 having a lower through hole H1 through which the rotary shaft 550 passes. The upper through hole H2 may overlap with the lower through hole H1 in the vertical direction.

The rotation support portion 420 may further include an anti-shake portion 423 surrounding the periphery of the rotary shaft 550 to prevent the rotary shaft 550 from shaking. For example, the anti-shake portion 423 may define the upper through hole H2. A diameter of the upper through hole H2 may correspond to an outer diameter of the rotary shaft 550. In other words, the diameter of the upper through hole H2 may be greater than the outer diameter of the rotary shaft 550, but the difference therebetween may be very small. For example, a difference between the diameter of the upper through hole H2 and the outer diameter of the rotary shaft 550 may be 1 mm or less. For example, a gap between the anti-shake portion 423 and the rotary shaft 550 may be 0.5 mm or less. For example, the difference between the diameter of the upper through hole H2 and the outer diameter of the rotary shaft 550 may be 0.6 mm or less. For example, the gap between the anti-shake portion 423 and the rotary shaft 550 may be 0.3 mm or less. For example, the difference between the diameter of the upper through hole H2 and the outer diameter of the rotary shaft 550 may be 0.4 mm or less. For example, the gap between the anti-shake portion 423 and the rotary shaft 550 may be 0.2 mm or less.

The anti-shake portion 423 of the upper support portion 422 may prevent foreign substances from penetrating into the bearing 440 from the outside of the rotation support portion 420. Accordingly, durability of the rotation support portion 420 may be secured.

The upper support portion 422 may be detachably assembled to the lower support portion 421. The upper support portion 422 may be arranged on the lower support portion 421. For example, the upper support portion 422 may be assembled to the lower support portion 421 by a plurality of fixing members S2.

The lower support portion 421 may be fixed to the mounting member 410 by the plurality of support ribs 470. The diameter of the lower through hole H1 may be greater than the diameter of the upper through hole H2. The bearing 440 may be arranged between the lower through hole H1 and the upper through hole H2. The diameter of the lower through hole H1 may be greater than the outer diameter of the bearing 440.

The rotation support portion 420 may further include a stopper 424 that limits a downward movement distance of the rotary shaft 550. The stopper 424 may be configured to define the lower through hole H1. For example, the diameter of the lower through hole H1 may be smaller than the outer diameter of the bearing 440 and greater than the outer diameter of the rotary shaft 550.

The rotary shaft 550 may extend in the vertical direction, and a path for transferring air discharged from the central cyclone unit 532 to the fixed portion 400 may be formed thereinside. The rotary shaft 550 may provide a path for transferring air discharged from the central cyclone unit 532 to the fixed portion 400. The bearing 440 may be arranged on the outer surface of the rotary shaft 550.

The bearing 440 may be fixed such that movement thereof in the vertical direction is limited with respect to the rotary shaft 550. For example, a first movement restriction portion 441 and a second movement restriction portion 551 arranged in the vertical direction may be arranged on the rotary shaft 550.

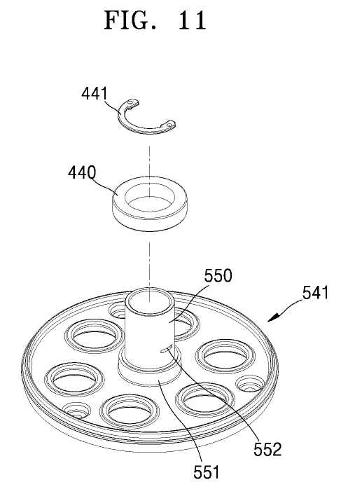

FIG. 11 is a diagram illustrating a first movement restriction portion of a rotary shaft, is detachably assembled according to an embodiment of the disclosure.

Referring to FIG. 11, the first movement restriction portion 441 may be positioned on the bearing 440 and restrict vertical movement of the bearing 440 relative to the rotary shaft 550. The first movement restriction portion 441 may be detachably assembled to the rotary shaft 550. For example, referring to FIG. 11, a fastening groove 552 may be provided on the outer surface of the rotary shaft 550, and the first movement restriction portion 441 may be a snap ring that is elastically deformable and is fixed to the fastening groove 552. However, the structure of the first movement restriction portion 441 is not limited thereto and may vary. For example, the first movement restriction portion 441 may be a pin structure fixed to the rotary shaft 550, and in this case, a pin hole into which a pin structure is inserted may be arranged in the rotary shaft 550 instead of the fastening groove 552.

The second movement restriction portion 551 may be positioned below the bearing 440 and restrict downward movement of the bearing 440 relative to the rotary shaft 550. The second movement restriction portion 551 may be fixed to the rotary shaft 550. For example, the second movement restriction portion 551 may be formed as a single body with the rotary shaft 550.

The rotation support portion 420 may be positioned so as not to obstruct the flow of air discharged from the air outlet 5312 of each of the plurality of cyclone units 531. For example, the rotation support portion 420 may be arranged so as not to overlap vertically with the air outlet 5312 of each of the plurality of cyclone units 531. The rotation support portion 420 may be arranged to overlap an area between the air outlet 5312 of the central cyclone unit 532 and the air outlet 5312 of each of the edge cyclone units 533. The plurality of support ribs 470 supporting the rotation support portion 420 may be arranged to overlap the areas between the air outlets 5312 of the respective edge cyclone units 533.

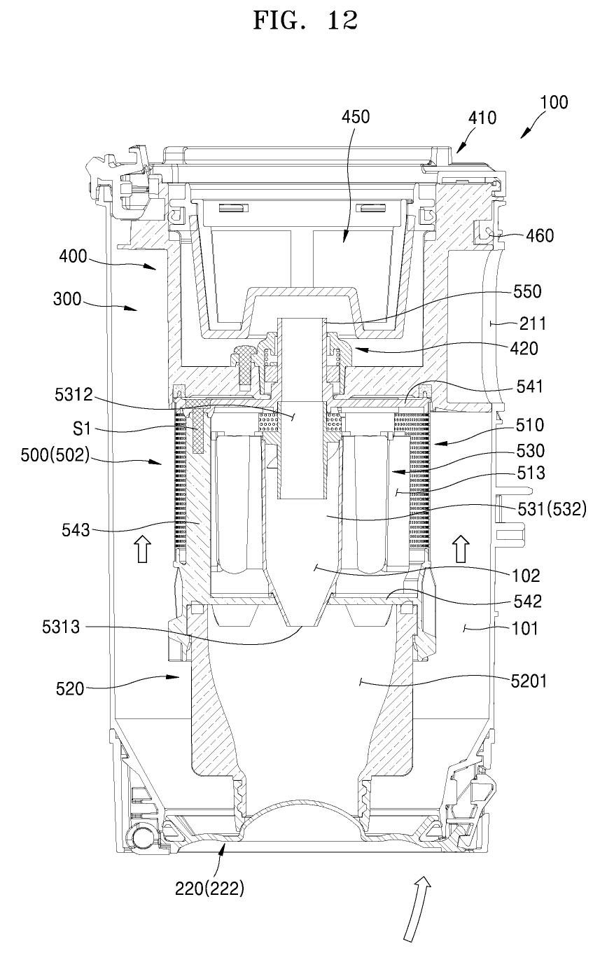

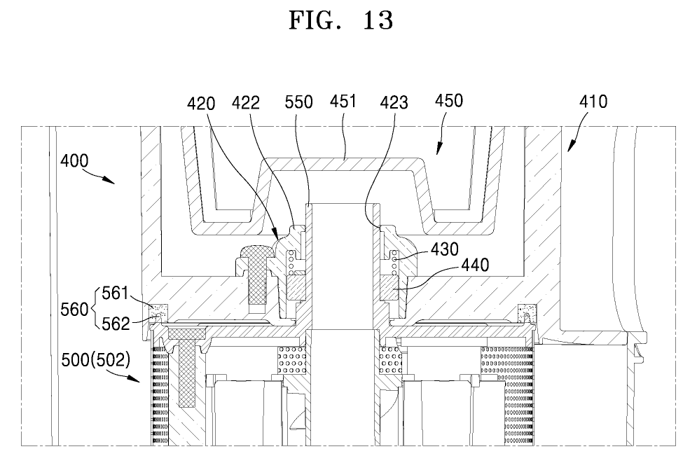

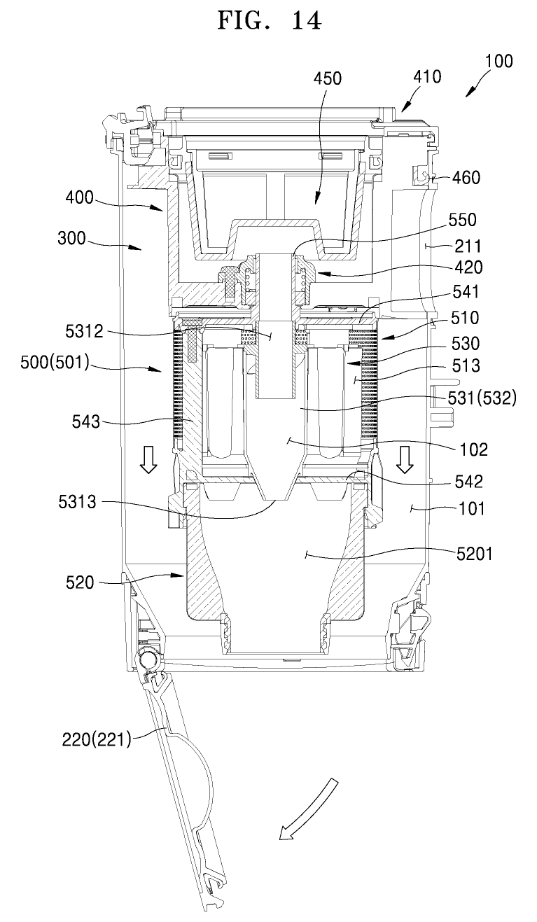

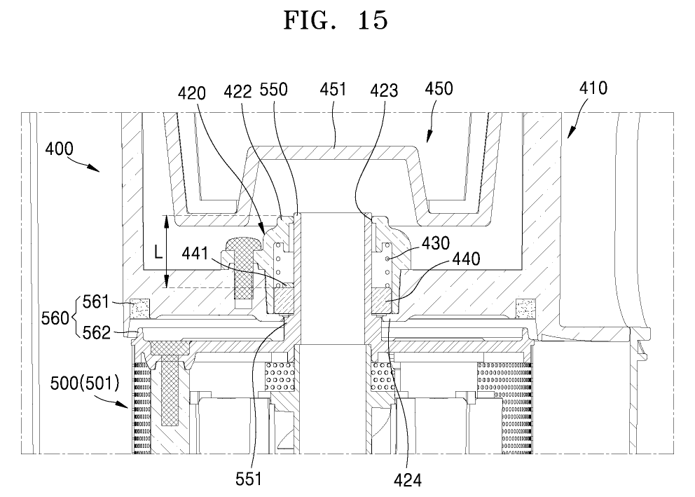

FIG. 12 is a cross-sectional view illustrating the appearance of the dust collecting apparatus 100 when the discharge door 220 is in the blocking position 222 according to an embodiment of the disclosure. FIG. 13 is an enlarged view focused on the rotation support portion 420 of the dust collecting apparatus 100 of FIG. 12 according to an embodiment of the disclosure. FIG. 14 is a cross-sectional view illustrating the appearance of the dust collecting apparatus 100 when the discharge door 220 is in the open position 221 according to an embodiment of the disclosure, and FIG. 15 is an enlarged view focused on the rotation support portion 420 in the dust collecting apparatus 100 of FIG. 14 according to an embodiment of the disclosure.

Referring to FIGS. 12 to 15, the rotating portion 500 of the cyclone module 300, according to an embodiment of the disclosure, may vary in rotational ability with respect to the fixed portion 400 depending on a position of the discharge door 220. For example, the rotating portion 500 may have the rotating state 501 in which the rotating portion 500 may rotate relative to the fixed portion 400 when the discharge door 220 is in the open position 221, and a locked state 502 in which rotation relative to the fixed portion 400 is restricted when the discharge door 220 is in the blocking position 222. When the discharge door 220 is switched from the blocking position 222 to the open position 221, the rotating portion 500 may be lowered and switched from the locked state 502 to the rotating state 501.

As an example for this, the cyclone module 300 may further include an anti-rotation portion 560 configured to provide rotational friction between the rotating portion 500 and the fixed portion 400 to prevent the rotating portion 500 from rotating relative to the fixed portion 400 when the rotating portion 500 is in the locked state 502.

The anti-rotation portion 560, according to an embodiment of the disclosure, may include a friction providing member 561 provided on one among the fixed portion 400 and the rotating portion 500, and a friction contact member 562 provided on the other among the fixed portion 400 and the rotating portion 500. When the rotating portion 500 is in the locked state 502, the friction contact member 562 may contact the friction providing member 561, and the rotational friction between the rotating portion 500 and the fixed portion 400 may increase. When the rotating portion 500 is in the rotating state 501, the friction contact member 562 is separated from the friction providing member 561, and the rotational friction between the rotating portion 500 and the fixed portion 400 may be reduced.

For example, in the dust collecting apparatus 100 according to an embodiment of the disclosure, the friction providing member 561 may be provided in the fixed portion 400, and the friction contact member 562 may be provided in the rotating portion 500. For example, the friction providing member 561 may be arranged in a boundary area facing the upper plate 541 of the mounting member 410. The friction contact member 562 may be arranged on the upper plate 541 so as to face the friction providing member 561. As the dust collecting apparatus 100 according to the embodiment has a structure in which the rotating portion 500 rotates while being arranged under the fixed portion 400, the friction providing member 561 and the friction contact member 562 may each be a single piece. As described above, by reducing the number of friction providing members 561 and the number of friction contact members 562, the burden of quality control of the friction providing members 561 and the friction contact members 562 may be reduced.

The friction providing member 561 and the friction contact member 562 may be configured to provide rotational friction by contact. For example, the friction providing member 561 may include an elastically deformable material. For example, the friction contact member 562 may extend or protrude upward. When the friction contact member 562 contacts and presses the friction providing member 561, the friction providing member 561 may be compressed and deformed by the friction contact member 562, and rotational friction that prevents the rotating portion 500 from rotating relative to the fixed portion 400 may be applied between the friction contact member 562 and the friction providing member 561.

The cyclone module 300 may further include a pressurizing member 430 that pressurizes the rotating portion 500 to switch from the locked state 502 to the rotating state 501. The pressurizing member 430 may pressurize the rotating portion 500 such that the rotating portion 500 descends. For example, the pressurizing member 430 may be a spring that provides elastic force in the vertical direction to the rotating portion 500. The pressurizing member 430 may be arranged inside the rotation support portion 420. For example, the pressurizing member 430 may be arranged between the upper support portion 422 and the bearing 440. The pressurizing member 430 may be elastically deformed in the vertical direction without rotation.

However, the position and type of the pressurizing member 430 are not limited thereto, and may be modified in various ways as long as a pressurizing force is provided to switch the rotating portion 500 from the locked state 502 to the rotating state 501. For example, although not shown, the pressurizing member 430 may be a magnet that provides magnetic force in the vertical direction to the rotating portion 500. The pressurizing member 430 may pressurize the rotating portion 500 downward by a repulsive force of the magnetic force.

Referring to FIGS. 12 and 13, when the discharge door 220 is in the blocking position 222, the discharge door 220 contacts the rotating portion 500 and presses the rotating portion 500 upward. While the rotating portion 500 is pressurized to move upward, the friction contact member 562 provided on at the upper portion of the rotating portion 500 compressively deforms the friction providing member 561 provided at the lower portion of the fixed portion 400, and rotational friction is applied between the rotating portion 500 and the fixed portion 400. Accordingly, the rotating portion 500 does not rotate. The rotating portion 500 is in the locked state 502.

Referring to FIGS. 14 and 15, when the discharge door 220 is switched from the blocking position 222 to the open position 221, the pressurizing member 430 may provide a pressing force such that the rotating portion 500 is switched from the locked state 502 to the rotating state 501. When the discharge door 220 is switched from the blocking position 222 to the open position 221, the rotating portion 500 may be subjected to gravity according to the weight of the rotating portion 500 and a pressing force by the pressurizing member 430, such that the rotating portion 500 is switched from the locked state 502 to the rotating state 501.

Referring to FIG. 15, the cyclone module 300, according to an embodiment of the disclosure, may further include the stopper 424 configured to restrict a lowering position of the rotating portion 500 when the rotating portion 500 descends. The stopper 424 may be provided on the fixed portion 400. For example, the stopper 424 may be provided inside the rotation support portion 420. The stopper 424 may be configured to define the lower through hole H1.

By the first movement restriction portion 441 and the second movement restriction portion 551, the bearing 440 is fixed in position in the vertical direction with respect to the rotary shaft 550. When the rotary shaft 550 moves in the vertical direction, the bearing 440 may move in the vertical direction together with the rotary shaft 550. When the rotating portion 500 descends, the rotary shaft 550 and the bearing 440 fixed to the rotary shaft 550 descend together. The stopper 424 may restrict the lowering position of the rotating portion 500 by restricting lowering of the bearing 440.

The rotating portion 500 may rotate around the rotary shaft 550. The rotary shaft 550 of the rotating portion 500 rotates by the bearing 440, but is supported by the anti-shake portion 423 at a different height from the bearing 440.

A vertical distance L between the anti-shake portion 423 and the bearing 440 may be greater than a height of the bearing 440. For example, when the rotating portion 500 is in the rotating state 501, the vertical distance L between the anti-shake portion 423 and the bearing 440 may be twice or more of the height of the bearing 440. When the rotating portion 500 is in the rotating state 501, the vertical distance L between the anti-shake portion 423 and the bearing 440 may be at least 1/3 a height of the rotary shaft 550. When the rotating portion 500 is in the rotating state 501, the vertical distance L between the anti-shake portion 423 and the bearing 440 may be 5 mm or more. However, the vertical distance L between the anti-shake portion 423 and the bearing 440 may be less than the height of the rotary shaft 550.

As described above, the cyclone module 300 according to the embodiment described above has a structure in which the rotating portion 500 may move and rotate in the vertical direction with respect to the fixed portion 400. However, the cyclone module 300, compared to a cyclone module that does not include the rotating portion 500, further includes a structure for moving and rotating the rotating portion 500 in the vertical direction. The structure for moving and rotating in the vertical direction of the rotating portion 500 may cause pressure loss that may weaken the performance of the cyclone module 300. In order to address the pressure loss, a method of increasing the size of the dust collecting apparatus 100 may be considered, but this may not be in line with the trend toward a smaller or more compact dust collecting apparatus 100.

In the cyclone module 300 according to an embodiment of the disclosure, the rotating portion 500 may move and rotate in the vertical direction with respect to the fixed portion 400, but a structure for minimizing pressure loss may be provided.

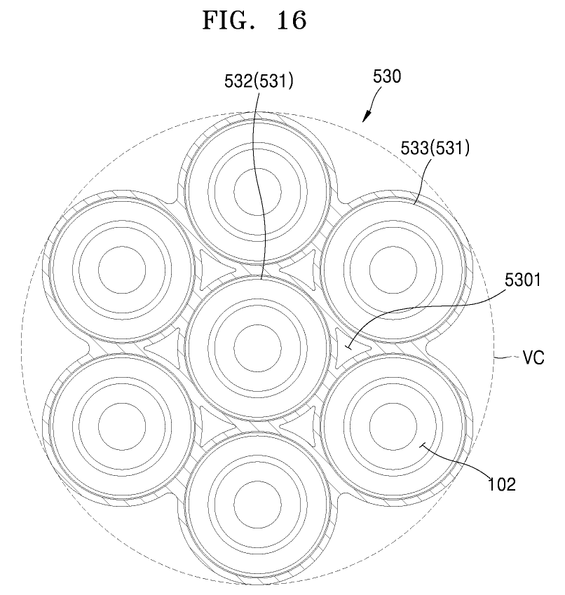

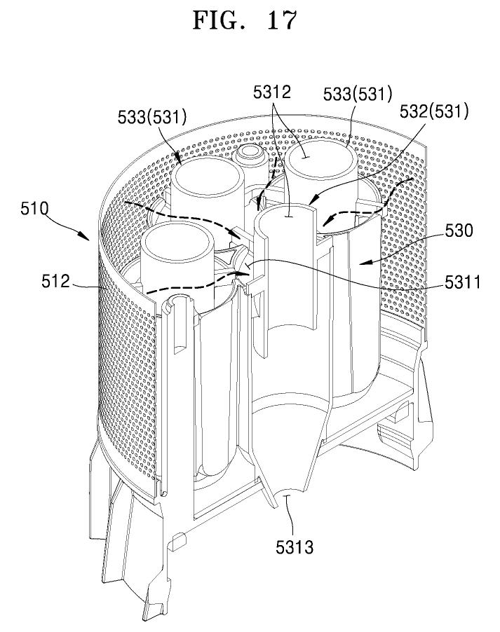

FIG. 16 is a horizontal cross-sectional view of a cyclone body of FIG. 9 according to an embodiment of the disclosure. FIG. 17 is a diagram illustrating a function of a cyclone body in a cyclone module 3according to an embodiment of the disclosure.

Referring to FIGS. 9 and 16, in the cyclone module 300 according to an embodiment of the disclosure, the cyclone body 530 may include the plurality of cyclone units 531, and a structure may be provided that minimizes the area in which the plurality of cyclone bodies 530 are not arranged.

For example, in the cyclone module 300, the rotary shaft 550 and the rotation support portion 420, which are components that support the rotating portion 500 to enable rotation and vertical movement of the rotating portion 500, may be arranged above the cyclone body 530.

By arranging the rotary shaft 550 and the rotation support portion 420 above rather than below the cyclone body 530, the cyclone unit 531 may be arranged at a center of rotation of the cyclone body 530. For example, the cyclone body 530 may include the central cyclone unit 532 arranged at the center of rotation and a plurality of edge cyclone units 533 arranged around the central cyclone unit 532. The plurality of cyclone units 531 may be divided into the central cyclone unit 532 and the plurality of edge cyclone units 533.

A cross-sectional shape of each of the central cyclone unit 532 and the plurality of edge cyclone units 533 may be circular. The shape of each of the central cyclone unit 532 and the plurality of edge cyclone units 533 may be the same. For example, a cross-sectional area of the central cyclone unit 532 may be the same as a cross-sectional area of the edge cyclone unit 533. However, the cross-sectional areas of the central cyclone unit 532 and the edge cyclone unit 533 do not necessarily have to be the same, and the cross-sectional areas of the central cyclone unit 532 and the edge cyclone unit 533 may be different as needed.

The central cyclone unit 532 and the plurality of edge cyclone units 533 may be arranged to contact each other. Accordingly, a plurality of gaps 5301 defined by the central cyclone unit 532 and the adjacent edge cyclone units 533 may be minimized.

In the cyclone body 530, a virtual circle VC may be formed in which outer surfaces of the plurality of edge cyclone units 533 are connected to each other, as shown in FIG. 16. Within the virtual circle VC, the second cyclone 102 formed by the central cyclone unit 532 and the plurality of edge cyclone units 533 is arranged. By arranging the central cyclone unit 532 and the plurality of edge cyclone units 533, pressure loss may be minimized.

Referring to FIGS. 9 and 17, the central cyclone unit 532 is a structure surrounded by the plurality of edge cyclone units 533. Considering the arrangement of the central cyclone unit 532, the shapes of air inlets 5311 and the air outlets 5312 may be determined such that air may be introduced into the central cyclone unit 532.

For example, each of the plurality of cyclone units 531 of the cyclone body 530 includes the air outlet 5312 disposed at the upper portion thereof. The air inlet 5311 may be provided around each of the air outlets 5312.

The air outlet 5312 may protrude upwards compared to the air inlet 5311. For example, the air outlet 5312 of each of the plurality of edge cyclone units 533 protrudes relative to the air inlet 5311. Accordingly, a space for airflow may be provided between the air outlets 5312 of adjacent border cyclone units 533. Air that has moved between the air outlets 5312 of the edge cyclone unit 533 may be introduced into the air inlet 5311 of the central cyclone unit 532.

For example, when air is drawn in through the mesh filter 512, a portion of the drawn in air may be introduced into the air inlets 5311 of the edge cyclone units 533, and another portion of the drawn in air may pass between the air outlets 5312 of the edge cyclone units 533. Air that has moved between the air outlets 5312 of the edge cyclone unit 533 may be introduced into the air inlets 5311 of the central cyclone unit 532.

As described above, in the cyclone body 530 according to an embodiment of the disclosure, as the air outlets 5312 of the plurality of cyclone units 531 protrude upward, air passing through the mesh filter 512 may be uniformly introduced into the plurality of edge cyclone units 533 as well as the central cyclone unit 532.

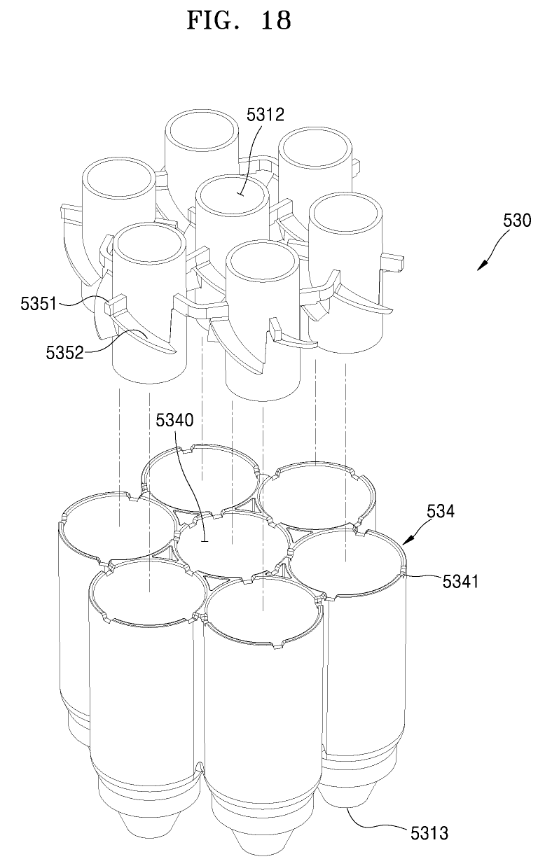

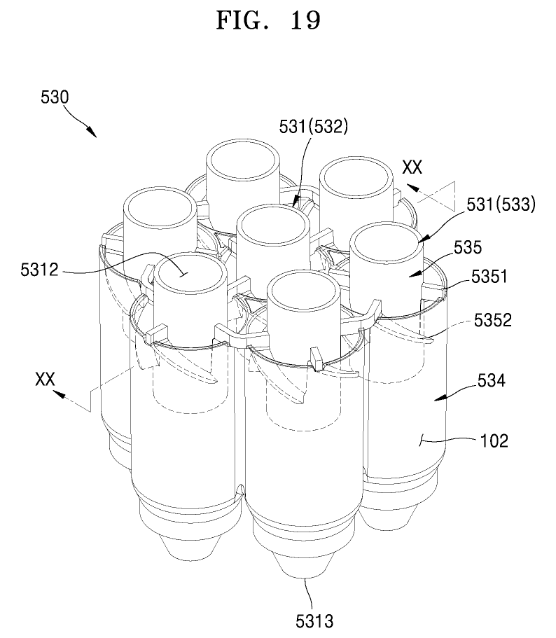

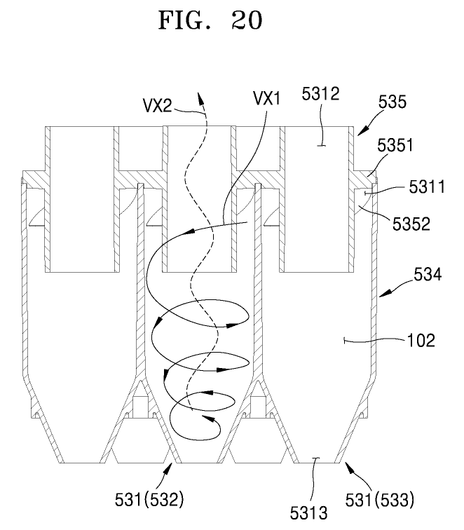

FIG. 18 is an exploded perspective view illustrating a cyclone body of a dust collecting apparatus according to an embodiment of the disclosure, and FIG. 19 is an assembled perspective view of a cyclone body of FIG. 18 according to an embodiment of the disclosure. FIG. 20 is a diagram illustrating an operation of a cyclone body of FIG. 19, and is a cross-sectional view of a cyclone body 530 FIG. 19 taken along line XX-XX according to an embodiment of the disclosure.

Referring to FIGS. 18 and 19, each of the plurality of cyclone units 531 of the cyclone body 530, according to an embodiment of the disclosure, may include a first body 534 having the foreign substance discharge port 5313 and a second body 535 having the air outlet 5312.

The first body 534 provides the second cyclone 102 thereinside and has a lower portion having a diameter decreasing toward the foreign substance discharge port 5313. An upper portion of the first body 534 may have an opening 5340 into which a portion of the second body 535 is inserted. A diameter of the opening 5340 is greater than a diameter of the second body 535.

The second body 535 may have an approximately cylindrical shape and may have the air outlet 5312 provided at an upper portion thereof. The second body 535 may define the air inlet 5311 together with the first body 534. For example, the air inlet 5311 may be defined by an inner surface of the first body 534 and an outer surface of the second body 535. In other words, the air inlet 5311 may be a space between the first body 534 and the second body 535.

The second body 535 may include a plurality of body support portions 5351 supported on an upper portion of the first body 534 such that the air outlet 5312 is positioned above the opening 5340 of the first body 534. A plurality of grooves 5341 may be provided in the upper portion of the first body 534 in which the plurality of body support portions 5351 are mounted. The body support portions 5351 may connect between the plurality of second bodies 535. The plurality of second bodies 535 may be a single body.

The second body 535 may include an air guide 5352 arranged on the outer surface thereof. The air guide 5352 may have a spiral shape. The air guide 5352 may be arranged at the bottom of the body support portion 5351. When a portion of the second body 535 is inserted into the opening 5340, the air guide 5352 may be located inside the first body 534. The air guide 5352 may guide the air introduced through the air inlet 5311 to move downward along the spiral shape.

Referring to FIG. 20, in each of the plurality of cyclone units 531 of the cyclone body 530 according to an embodiment of the disclosure, air including foreign substances is introduced through the air inlet 5311 provided between the first body 534 and the second body 535.

Air drawn in through the air inlet 5311 forms a descending swirling flow (VX1, vortex) by the air guide 5352 of the second body 535. The descending swirling flow VX1 moves downward in a spiral manner along the inner surface of the first body 534.

As the diameter of the first body 534 decreases toward the foreign substance discharge port 5313, the speed of the swirling flow VX1 gradually increases. Foreign substances in the air are separated from the swirling flow VX1 and discharged through the foreign substance discharge port 5313.

The descending swirling flow VX1 is converted into an internal airflow VX2 rising from a lower portion of the first body 534. The internal airflow VX2 moves upward along a center of the first body 534. By the internal airflow VX2, the air from which foreign substances have been separated is discharged through the air outlet 5312.

Referring again to FIG. 10, the fixed portion 400 may further include the dust collection filter 450 that removes dust in the air discharged from the cyclone body 530. The dust collection filter 450 may include a filter groove 451 provided in a lower portion thereof. The filter groove 451 is upwardly concave. Through the filter groove 451, the dust collection filter 450 may be separated from an end of the rotary shaft 550. The filter groove 451 may have a predetermined depth so as to be spaced apart from the end of the rotary shaft 550. A diameter of the upper surface of the filter groove 451 may be greater than the outer diameter of the rotary shaft 550.

The dust collection filter 450 may have an increased filter area through the filter groove 451 positioned in the lower portion thereof. The dust collection filter 450 may be spaced apart from the end of the rotary shaft 550 through the filter groove 451, while reducing the increase in height of the dust collecting apparatus 100 due to the protruding height of the rotary shaft 550.

For the purposes of promoting understanding of the disclosure, reference has been made to the preferred embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art.

The particular implementations shown and described herein are illustrative examples of the disclosure and are not intended to otherwise limit the scope of the disclosure in any way. For the sake of brevity, electronics of the related art, control systems, software development and other functional aspects of the systems may not be described below. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as "essential" or "critical". Expressions, such as "comprising," "including," or the like, used herein are used to be understood as open-ended terms.

Recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein may be performed in any suitable order unless otherwise indicated herein or otherwise clearly contradicted by context. The disclosure is not necessarily limited by the order of description of the above steps. The use of any and all examples, or language (e.g., "such as") provided herein, is intended merely to better illuminate the disclosure and does not pose a limitation on the scope of the disclosure unless otherwise claimed. In addition, numerous modifications and adaptations will be readily apparent to those skilled in this art without departing from the spirit and scope of the disclosure.

According to a dust collecting apparatus, a vacuum cleaner, and a cleaning apparatus, according to an embodiment of the disclosure, a rotating portion, which is a component of a cyclone module, is rotatable to minimize foreign substances remaining inside the dust collecting apparatus, and pressure loss in the cyclone module due to a structure for rotating the rotating portion may be minimized.

A dust collecting apparatus, according to an embodiment of the disclosure, may include a dust collection case having a foreign substance discharge port,; a cyclone module disposed inside the dust collection case and configured to induce a swirling airflow to separate foreign substances, and a discharge door movable between an open position for opening the foreign substance discharge port and a blocking position for blocking the foreign substance discharge port.

The cyclone module may include a fixed portion assembled to be fixed to the dust collection case, and a rotating portion that is movable in a vertical direction with respect to the fixed portion, and has a rotation state that is rotatable relative to the fixed portion when the discharge door is in the open position, and a locked state in which rotation relative to the fixed portion is restricted when the discharge door is in the blocking position.

The rotating portion may include a cyclone body including a central cyclone unit disposed at a center of rotation, and a plurality of edge cyclone units arranged around the central cyclone unit, and a rotary shaft arranged on the central cyclone unit such that the cyclone body is rotatable relative to the fixed portion, and providing a path for transferring air discharged from the central cyclone unit to the fixed portion.

The rotating portion may further include a bearing provided on an outer surface of the rotary shaft, and the fixed portion may include a rotation support portion that supports the bearing such that the rotary shaft is rotatable.

The rotary support may include a lower support having a lower through hole through which the rotary shaft passes, and an upper support having an upper through hole disposed above the lower support and overlapping the lower through hole.

The rotation support portion may further include an anti-shake portion that is positioned at a different height from the bearing and surrounds a periphery of the rotary shaft to prevent the rotary shaft from shaking.

The anti-shake portion may be configured to define the upper through hole.

The rotary support may further include a stopper configured to restrict a downward movement distance of the rotary shaft.

The stopper may define the lower through hole, a diameter of the lower through hole may be less than an outer diameter of the bearing and greater than an outer diameter of the rotary shaft.

The fixed portion may further include a dust collection filter that removes dust from air discharged from the cyclone body, and a filter groove may be provided in a lower portion of the dust collection filter and formed to be upwardly concave and spaced apart from an end of the rotary shaft.

The dust collection case may further includes an air inlet for introducing air from the outside when the discharge door is in the blocking position, and an air outlet for discharging air from which foreign substances have been separated, and when the discharge door is in the open position, airflow is permitted to enter through the air inlet and the air outlet, foreign substances separated by the cyclone module are permitted to be discharged through the foreign substance discharge port, and the rotating portion may include a rotation induction portion configured to receive rotational force by the airflow introduced through at least one of the air inlet and the air outlet.

The rotation induction portion may include a rotation blade arranged on an outer surface of the rotating portion.

The apparatus may further include an anti-rotation portion configured to provide rotational friction between the rotating portion and the fixed portion to prevent the rotating portion from rotating relative to the fixed portion when the rotating portion is in the locked state, wherein the anti-rotating portion includes a friction providing member provided in one of the fixed portion and the rotating portion, and a friction contact member which is provided in the other among the fixed portion and the rotating portion and which contacts and presses the friction providing member when the rotating portion is in the locked state.

The rotating portion may further include an upper plate supporting the rotary shaft and arranged on the cyclone body, and a lower plate which is arranged below the cyclone body and supports the cyclone body together with the upper plate, and an inner case surrounding the cyclone body and having a mesh filter, and a dust separation member having a dust collecting chamber in which foreign substances separated from the cyclone body are collected.

The cyclone module may further include a pressurizing member which is disposed inside the rotation support portion, and pressurizes the rotating portion such that the rotating portion is switched from the locked state to the rotating state.

A vacuum cleaner, according to an embodiment of the disclosure, may have a dust collecting apparatus according to the embodiment described above.

A cleaning apparatus, according to an embodiment of the disclosure, may include a vacuum cleaner having the dust collecting apparatus according to the embodiment described above, and a cleaner station including a docking portion to which the dust collecting apparatus is connectable, a suction portion that provides suction power to discharge foreign substances collected in the dust collecting apparatus, and a collecting portion that collects the discharged foreign substances.

According to an embodiment of the disclosure, a dust collecting apparatus having a rotating structure in which a rotating portion, which is a component of a cyclone module, may rotate relative to a fixed portion to minimize foreign substances remaining inside the dust collecting apparatus, and minimize pressure loss of the cyclone module, and a vacuum cleaner, and a cleaning apparatus may be provided.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A dust collecting apparatus comprising:
a dust collection case including a foreign substance discharge port;
a cyclone module arranged inside the dust collection case and configured to induce a swirling airflow to separate foreign substances; and
a discharge door that is movable between an open position that opens the foreign substance discharge port and a blocking position that blocks the foreign substance discharge port,
wherein the cyclone module comprises:
a fixed portion assembled to be fixed to the dust collection case; and
a rotating portion that is movable in a vertical direction with respect to the fixed portion, has a rotating state that is rotatable relative to the fixed portion when the discharge door is in the open position, and has a locked state in which rotation relative to the fixed portion is restricted when the discharge door is in the blocking position, and
wherein the rotating portion comprises:
a cyclone body including a central cyclone unit arranged at a center of rotation and a plurality of edge cyclone units arranged around the central cyclone unit; and
a rotary shaft arranged on the central cyclone unit such that the cyclone body is rotatable relative to the fixed portion, and providing a path for transferring air discharged from the central cyclone unit to the fixed portion.

2. The dust collecting apparatus of claim 1,
wherein the rotating portion further comprises a bearing provided on an outer surface of the rotary shaft, and
wherein the fixed portion includes a rotation support portion that supports the bearing such that the rotary shaft is rotatable.

3. The dust collecting apparatus of claim 2, wherein the rotation support portion comprises:
a lower support portion having a lower through hole H1 through which the rotary shaft passes; and
an upper support portion arranged on the lower support portion and having an upper through hole H2 overlapping the lower through hole.

4. The dust collecting apparatus of claim 3, wherein the rotation support portion further comprises:
an anti-shake portion disposed at a different height from the bearing and surrounding a periphery of the rotary shaft to prevent the rotary shaft from shaking.

5. The dust collecting apparatus of claim 4, wherein the anti-shake portion is configured to define the upper through hole H2.

6. The dust collecting apparatus of claim 5, wherein the rotation support portion further includes a stopper configured to restrict a downward movement distance of the rotary shaft.

7. The dust collecting apparatus of claim 6,
wherein the stopper defines the lower through hole H1, and
wherein a diameter of the lower through hole is less than an outer diameter of the bearing and greater than an outer diameter of the rotary shaft.

8. The dust collecting apparatus of claim 1,
wherein the fixed portion further comprises a dust collection filter that removes dust from the air discharged from the cyclone body, and
wherein a filter groove is provided in a lower portion of the dust collection filter and formed to be upwardly concave and spaced apart from an end of the rotary shaft.

9. The dust collecting apparatus of claim 8,
wherein the dust collection case further comprises an air inlet through which air is drawn in from outside when the discharge door is in the blocking position, and an air outlet through which air from which foreign substances have been separated is discharged,
wherein when the discharge door is in the open position, airflow is permitted to enter through the air inlet and the air outlet, and foreign substances separated by the cyclone module are permitted to be discharged through the foreign substance discharge port, and
wherein the rotating portion further comprises a rotation induction portion configured to receive a rotating force by airflow introduced through at least one of the air inlet or the air outlet.

10. The dust collecting apparatus of claim 9, wherein the rotation induction portion comprises rotation blades arranged on an outer surface of the rotating portion.

11. The dust collecting apparatus of claim 1, further comprising:
an anti-rotation portion configured to provide rotational friction between the rotating portion and the fixed portion to prevent the rotating portion from rotating relative to the fixed portion when the rotating portion is in the locked state,
wherein the anti-rotating portion comprises:
a friction providing member provided in one of the fixed portion or the rotating portion; and
a friction contact member which is provided in the other among the fixed portion and the rotating portion and which contacts and presses the friction providing member when the rotating portion is in the locked state.

12. The dust collecting apparatus of claim 1, wherein the rotating portion further comprises:
an upper plate supporting the rotary shaft and arranged on the cyclone body;
a lower plate which is arranged below the cyclone body and supports the cyclone body together with the upper plate;
an inner case surrounding the cyclone body and having a mesh filter; and
a dust separation member having a dust collecting chamber in which foreign substances separated from the cyclone body are collected.

13. The dust collecting apparatus of claim 2, wherein the cyclone module further comprises a pressurizing member which is disposed inside the rotation support portion and pressurizes the rotating portion such that the rotating portion is switched from the locked state to the rotating state.

14. A vacuum cleaner including a dust collecting apparatus comprising:
a dust collection case including a foreign substance discharge port;
a cyclone module arranged inside the dust collection case and configured to induce a swirling airflow to separate foreign substances; and
a discharge door that is movable between an open position that opens the foreign substance discharge port and a blocking position that blocks the foreign substance discharge port,
wherein the cyclone module comprises:
a fixed portion assembled to be fixed to the dust collection case; and
a rotating portion that is movable in a vertical direction with respect to the fixed portion, has a rotating state that is rotatable relative to the fixed portion when the discharge door is in the open position, and has a locked state in which rotation relative to the fixed portion is restricted when the discharge door is in the blocking position, and
wherein the rotating portion comprises:
a cyclone body including a central cyclone unit arranged at a center of rotation and a plurality of edge cyclone units arranged around the central cyclone unit; and
a rotary shaft arranged on the central cyclone unit such that the cyclone body is rotatable relative to the fixed portion, and providing a path for transferring air discharged from the central cyclone unit to the fixed portion.

15. A cleaning apparatus comprising:
a vacuum cleaner including a dust collecting apparatus; and
a cleaner station including a docking portion to which the dust collecting apparatus is connectable, a suction portion that provides suction power to discharge foreign substances collected in the dust collecting apparatus, and a collecting portion that collects the discharged foreign substances,
wherein the dust collecting apparatus comprises:
a dust collection case including a foreign substance discharge port;
a cyclone module arranged inside the dust collection case and configured to induce a swirling airflow to separate foreign substances; and
a discharge door that is movable between an open position that opens the foreign substance discharge port and a blocking position that blocks the foreign substance discharge port,
wherein the cyclone module comprises:
a fixed portion assembled to be fixed to the dust collection case; and
a rotating portion that is movable in a vertical direction with respect to the fixed portion, has a rotating state that is rotatable relative to the fixed portion when the discharge door is in the open position, and has a locked state in which rotation relative to the fixed portion is restricted when the discharge door is in the blocking position, and
wherein the rotating portion comprises:
a cyclone body including a central cyclone unit arranged at a center of rotation and a plurality of edge cyclone units arranged around the central cyclone unit; and
a rotary shaft arranged on the central cyclone unit such that the cyclone body is rotatable relative to the fixed portion, and providing a path for transferring air discharged from the central cyclone unit to the fixed portion.

16. The cleaning apparatus of claim 15,
wherein the rotating portion further comprises a bearing provided on an outer surface of the rotary shaft, and
wherein the fixed portion includes a rotation support portion that supports the bearing such that the rotary shaft is rotatable.

17. The cleaning apparatus of claim 16, wherein the rotation support portion comprises:
a lower support portion having a lower through hole H1 through which the rotary shaft passes; and
an upper support portion arranged on the lower support portion and having an upper through hole H2 overlapping the lower through hole.

18. The cleaning apparatus of claim 17, wherein the rotation support portion further comprises:
an anti-shake portion disposed at a different height from the bearing and surrounding a periphery of the rotary shaft to prevent the rotary shaft from shaking.

19. The cleaning apparatus of claim 18, wherein the anti-shake portion is configured to define the upper through hole H2.
